(19) United States
(12) Patent Application Publication
(10) Pub. No.: US 2018/0096403 A1
(43) Pub. Date: Apr. 5, 2018

(54) FACILITY SATISFACTION RATE CALCULATING APPARATUS

(71) Applicant: HONDA MOTOR CO., LTD., Tokyo (JP)

(72) Inventors: Hiromitsu Yuhara, Tokyo (JP); Tomoko Shintani, Tokyo (JP); Eisuke Soma, Tokyo (JP); Shinichiro Goto, Saitama (JP)

(21) Appl. No.: 15/715,448

(22) Filed: Sep. 26, 2017

(30) Foreign Application Priority Data
Sep. 30, 2016 (JP) 2016-193254

(51) Int. Cl. G06Q 30/02

(52) U.S. Cl. CPC G06Q 30/0282; H04W 4/008

(57) ABSTRACT

Provided is an apparatus which can realize improvement of estimation accuracy of a satisfaction rate of a passenger of a vehicle with respect to a facility. A visit determining unit 42 determines whether or not a vehicle X has visited a facility. An emotion estimating unit 43 estimates emotion of one or more passengers of the vehicle X based on information relating to a state of the passengers. In the case where it is determined by the visit determining unit 42 that the vehicle X has visited the facility, the index value evaluating unit 44 evaluates an index value of a satisfaction rate of the passenger with respect to the facility based on the emotion of the passenger estimated by the emotion estimating unit 43 within a designated period of time since the vehicle X has left the facility.

### BACKGROUND OF THE INVENTION

### Field of Invention

The present invention relates to an apparatus which executes communication with a driver of a vehicle.

### Description of the Related Art

In recent years, a technique which allows a computer to estimate emotion (feeling) of a human based on speech uttered from the human and expression has been developed. It is expected that such an emotion estimation technique is applied to realization of smooth dialogue, or the like, by returning a response based on emotion of a human, for example, in the case where the human interacts with a computer. As the emotion estimation technique, for example, a technique has been proposed in which emotion is determined by extracting a characteristic amount corresponding to emotion from a speech signal and detecting an amount of deviation from a reference speech signal (see Japanese Patent Laid-Open No. H05-12023). Further, a technique for estimating a psychological state by obtaining a level of certainty of emotion with respect to a plurality of types of basic emotion set in advance for an image of expression of a human, particularly, a shape of the eyes and the mouth has been proposed (see Japanese Patent Laid-Open No. 2007-65969),

An information system which collects information relating to a satisfaction rate (degree) from people who have already visited a specific area such as an event and shopping, and releases the information on a network has been proposed (see Japanese Patent No. 4296411). When an information center transmits a question relating to a satisfaction rate of a passenger of a vehicle, the information center selects a vehicle which is stopped based on velocity information and transmits the question to the vehicle. In the case where the information center judges that the vehicle is moving, the information center transmits a question only in the case where it is judged that there is a passenger other than a driver on the vehicle based on information relating to the passenger. As such, it is possible to prevent transmitting a question when there is no passenger other than the driver and the vehicle is moving, so that it is possible to secure safety of a respondent.

However, there is a case where estimation accuracy of a satisfaction rate of a passenger with respect to a facility becomes low only from a question to the passenger of the vehicle and a reply from the passenger. For example, even if a passenger of the vehicle is satisfied with the facility the passenger has visited, there is a case where the passenger may utter a word against his or her intention because he or she does not want to end conversation with other passengers or does not want to ruin the atmosphere of enjoying the afterglow.

Therefore, the present invention is directed to providing an apparatus which can realize estimation accuracy of a satisfaction rate (degree) of a passenger of a vehicle with respect to a facility.

### SUMMARY OF THE INVENTION

A facility satisfaction rate calculating apparatus of the present invention includes a visit determining unit configured to determine whether or not a vehicle has visited a facility, an emotion estimating unit configured to estimate emotion of one or more passengers of the vehicle based on information relating to a state of the one or more passengers, an index value evaluating unit configured to, in a case where it is determined by the visit determining unit that the vehicle has visited the facility, evaluate an index value of a satisfaction rate of the one or more passengers with respect to the facility based on emotion of the one or more passengers estimated by the emotion estimating unit within a designated period since the vehicle has left the facility, a number estimating unit configured to estimate a number of passengers of the vehicle, and a questioning unit configured to, in a case where it is estimated by the number estimating unit that there is only one passenger on the vehicle, output a question to the passenger.

In the facility satisfaction rate calculating apparatus of the present invention, in a case where it is determined by the visit determining unit that the vehicle has visited the facility and it is estimated by the number estimating unit that there are a plurality of passengers on the vehicle, it is preferable that the questioning unit outputs a question to the passengers under a condition that a degree of certainty of estimation of emotion of the passengers by the emotion estimating unit does not become equal to or higher than a predetermined value within the designated period.

In the facility satisfaction rate calculating apparatus of the present invention, it is preferable that the index value evaluating unit evaluates the index value of the satisfaction rate of the one or more passengers with respect to the facility based on emotion of the one or more passengers estimated by the emotion estimating unit within a predetermined period before the vehicle has arrived at the facility in addition to emotion of the one or more passengers estimated by the emotion estimating unit within the designated period since the vehicle has left the facility.

In the facility satisfaction rate calculating apparatus of the present invention, it is preferable that the information relating to a state of the one or more passengers of the vehicle is at least one of expression and action of the one or more passengers photographed by a camera and speech of the one or more passengers collected with a microphone.

According to the facility satisfaction rate calculating apparatus of the present invention, it is possible to realize improvement of estimation accuracy of a satisfaction rate of a passenger of a vehicle with respect to a facility.

### BRIEF DESCRIPTION OF THE DRAWINGS

FIG. 1 is an explanatory diagram of a configuration of a basic system;

FIG. 2 is an explanatory diagram of a configuration of an agent apparatus;

FIG. 3 is an explanatory diagram of a configuration of a mobile terminal apparatus;

FIG. 4 is an explanatory diagram of a configuration of a facility satisfaction rate calculating apparatus as an embodiment of the present invention; and

FIG. 5 is an explanatory diagram of functions of the facility satisfaction rate calculating apparatus.

### DETAILED DESCRIPTION OF THE PREFERRED EMBODIMENTS

### (Configuration of Basic System)

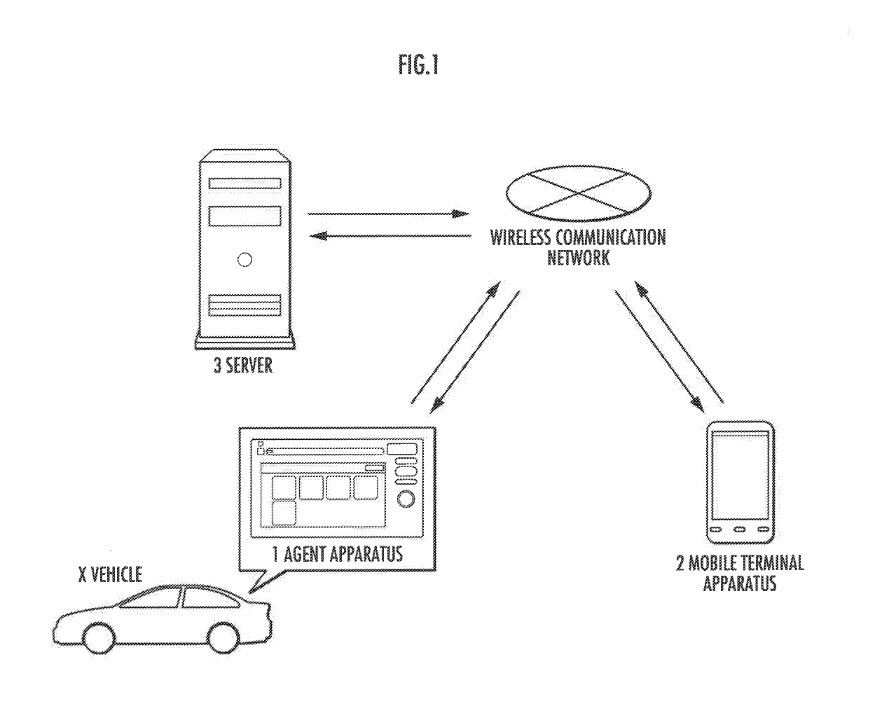

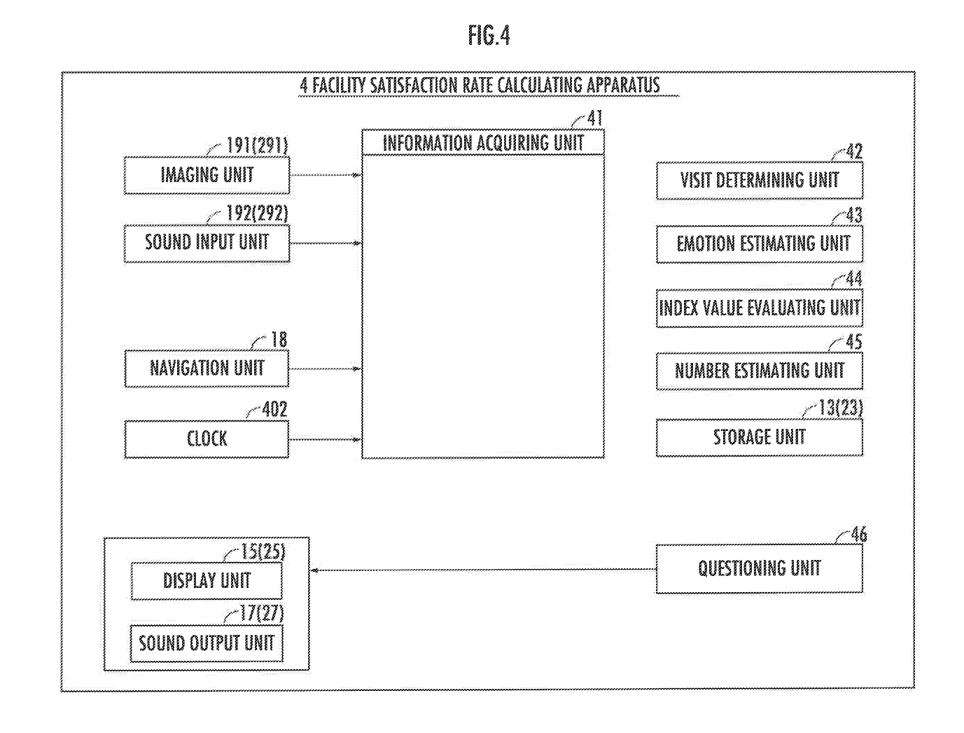

A facility satisfaction rate calculating apparatus 4 as an embodiment of the present invention (see FIG. 4) is configured with at least part of components of a basic system illustrated in FIG. 1. The basic system is configured with an agent apparatus 1 mounted on a vehicle X (mobile object), a mobile terminal apparatus 2 (for example, a smartphone) which can be carried inside the vehicle X by a passenger and a server 3. The agent apparatus 1, the mobile terminal apparatus 2 and the server 3 have a function of performing wireless communication with each other through a wireless communication network (for example, the Internet). The agent apparatus 1 and the mobile terminal apparatus 2 have a function of performing wireless communication with each other using a near field wireless system (for example, Bluetooth (“Bluetooth” is a registered trademark)) in the case where the agent apparatus 1 is physically in proximity to the mobile terminal apparatus 2, such as in the case where the agent apparatus 1 and the mobile terminal apparatus 2 coexist within space of the same vehicle X.

### (Configuration of Agent Apparatus)

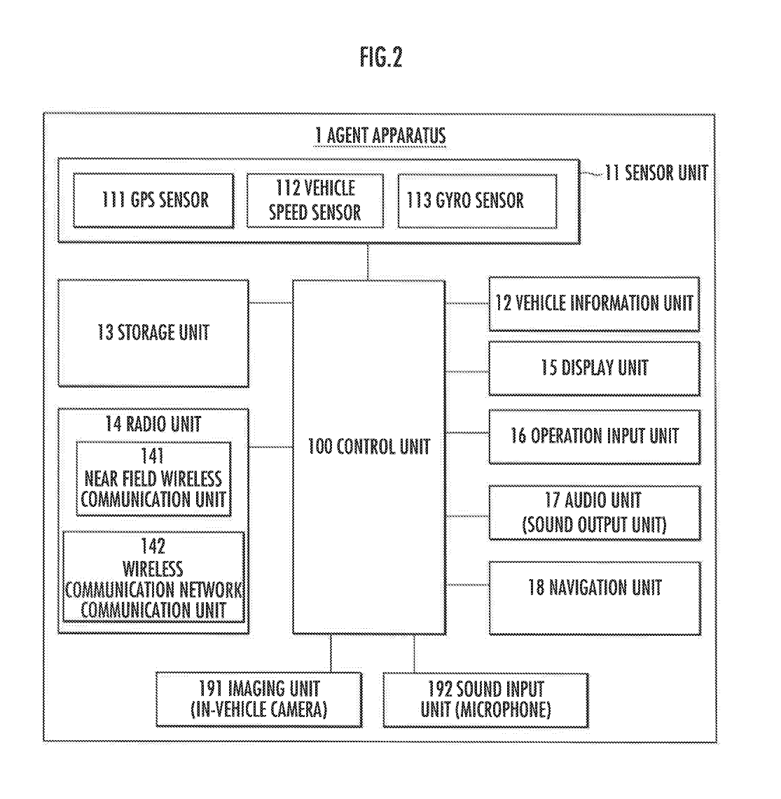

For example, as illustrated in FIG. 2, the agent apparatus 1 includes a control unit 100, a sensor unit 11 (including a GPS sensor 111, a vehicle speed sensor 112 and a gyro sensor 113), a vehicle information unit 12, a storage unit 13, a radio unit 14 (including a near field wireless communication unit 141 and a wireless communication network communication unit 142), a display unit 15, an operation input unit 16, an audio unit 17 (sound output unit), a navigation unit 18, an imaging unit 191 (in-vehicle camera) and a sound input unit 192 (microphone).

The GPS sensor 111 of the sensor unit 11 calculates a current position based on a signal from a GPS (Global Positioning System) satellite. The vehicle speed sensor 112 calculates speed of a vehicle based on a pulse signal from a rotating shaft of the vehicle speed sensor 112. The gyro sensor 113 detects angular velocity. It is possible to accurately calculate a current position and orientation of the vehicle with these GPS sensor, vehicle speed sensor and gyro sensor.

The vehicle information unit 12 acquires vehicle information through an in-vehicle network such as a CAN-BUS. The vehicle information includes information of, for example, ON or OFF of an ignition SW and an operation state of a safety apparatus system (such as an ADAS, an ABS and an air bag). The operation input unit 16 detects input of an operation amount of a steering, an accelerator pedal or a brake pedal which can be utilized to estimate emotion (feeling) of a passenger, operation of a window and an air conditioner (such as temperature setting), or the like, in addition to operation such as switch depression.

The near field wireless communication unit 141 of the radio unit 14 is, for example, a communication unit for Wi-Fi: Wireless Fidelity (registered trademark), Bluetooth (registered trademark), or the like, and the wireless communication network communication unit 142 is a communication unit connected to a wireless communication network typified by a so-called mobile telephone network such as 3G, cellular and LTE communication.

### (Configuration of Mobile Terminal Apparatus)

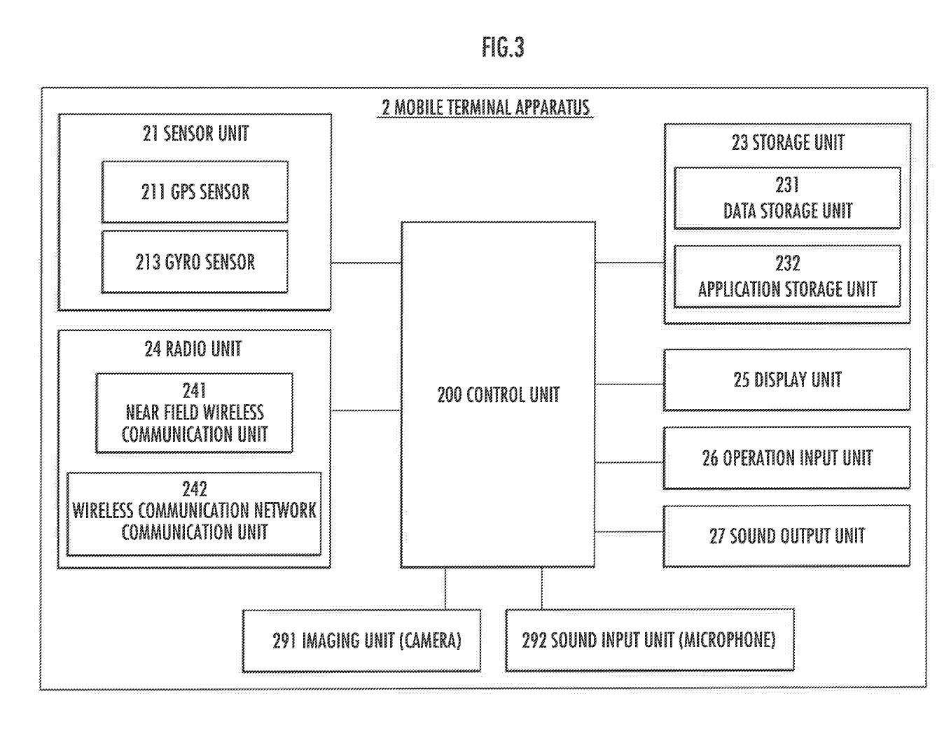

For example, as illustrated in FIG. 3, the mobile terminal apparatus 2 includes a control unit 200, a sensor unit 21 (including a GPS sensor 211 and a gyro sensor 213), a storage unit 23 (including a data storage unit 231 and an application storage unit 232), a radio unit 24 (including a near field wireless communication unit 241 and a wireless communication network communication unit 242), a display unit 25, an operation input unit 26, a sound output unit 27, an imaging unit 291 (camera) and a sound input unit 292 (microphone).

The mobile terminal apparatus 2 includes components in common with the agent apparatus 1. While the mobile terminal apparatus 2 does not include a component which acquires the vehicle information (see the vehicle information unit 12 in FIG. 2), the mobile terminal apparatus 2 can, for example, acquire vehicle information from the agent apparatus 1 through the near field wireless communication unit 241. Further, the mobile terminal apparatus 2 may include functions similar to those of the audio unit 17 and the navigation unit 18 of the agent apparatus 1 according to application (software) stored in the application storage unit 232.

### (Configuration of Facility Satisfaction Rate Calculating Apparatus)

The facility satisfaction rate calculating apparatus 4 as an embodiment of the present invention illustrated in FIG. 4 is configured with one or both of the agent apparatus 1 and the mobile terminal apparatus 2. It is also possible to configure part of components of the facility satisfaction rate calculating apparatus 4 as components of the agent apparatus 1 and other components of the facility satisfaction rate calculating apparatus 4 as components of the mobile terminal apparatus 2, and the agent apparatus 1 and the mobile terminal apparatus 2 may coordinate with each other so as to complement each other's components. Concerning symbols, description of N₁ (N₂) indicates configuration or execution by one or both of a component N₁ and a component N₂.

The facility satisfaction rate calculating apparatus 4 includes a storage unit 13 (23), an imaging unit 191 (291), a sound input unit 192 (292), a sound output unit 17 (27) (or an audio unit) and a navigation unit 18. The facility satisfaction rate calculating apparatus 4 includes an information acquiring unit 41, a visit determining unit 42, an emotion estimating unit 43, an index value evaluating unit 44 and a number estimating unit 45.

The information acquiring unit 41 acquires information relating to a state of a passenger such as a driver of the vehicle X as passenger state information based on output signals from the imaging unit 191 (291), the sound input unit 192 (292), the navigation unit 18 and a clock 402.

A moving image indicating behavior of a passenger imaged by the imaging unit 191 (291), such as an aspect where the passenger (particularly, the driver or a main passenger (first passenger) of the vehicle X) periodically moves part of the body (for example, the head) in rhythm to music output from the audio unit 17 may be acquired as the passenger state information. A moving image indicating behavior of a passenger imaged by the imaging unit 191 (291), such as an aspect where the passenger (particularly, a fellow passenger or a sub-passenger (second passenger) of the driver (first passenger) of the vehicle X) keeps his eyes closed, an aspect where the passenger views outside of the vehicle and an aspect where the passenger manipulates a smartphone may be acquired as the passenger state information. A moving image indicating reaction such as movement of the line of sight of the passenger (first passenger) in reaction to change of an output image or sound output of the navigation unit 18, imaged by the imaging unit 191 (291), may be acquired as the passenger state information.

Humming of the passenger detected by the sound input unit 192 (292) may be acquired as passenger information. Information relating to music content output from the audio unit 17 may be acquired as the passenger information. Conversation between the first passenger and the second passenger or content of utterance of the second passenger detected by the sound input unit 192 (292) may be acquired as in-vehicle state information.

Traveling cost (a distance, required traveling time, a level of traffic jam or an energy consumption amount) of a navigation route or roads included in a region covering the navigation route or links constituting the navigation route, transmitted from the server 3 to the facility satisfaction rate calculating apparatus 4 may be acquired as the passenger state information (traffic condition information). The navigation route is configured with a plurality of links which are successive from a current point or a starting point to a destination point, and is calculated by the navigation unit 18 or a navigation function of the mobile terminal apparatus 2 or the server 3. The current point of the facility satisfaction rate calculating apparatus 4 is measured by the GPS sensor 111 (211). The starting point and the destination point are set by the passenger through the operation input unit 16 (26) or the sound input unit 192 (292).

The visit determining unit 42 determines whether or not the vehicle X has visited a facility. The emotion estimating unit 43 estimates emotion of one or more passengers of the vehicle X based on information relating to a state of the one or more passengers. In the case where it is determined by the visit determining unit 42 that the vehicle X has visited the facility, the index value evaluating unit 44 evaluates an index value of a satisfaction rate (degree) of the one or more passengers with respect to the facility based on emotion of the one or more passengers estimated by the emotion estimating unit 43 within a designated period since the vehicle X has left the facility. The index value evaluating unit 44 evaluates the index value of the satisfaction rate of the one or more passengers with respect to the facility based on the emotion of the one or more passengers estimated by the emotion estimating unit 43 within a predetermined period before the vehicle X has arrived at the facility in addition to the emotion of the one or more passengers estimated by the emotion estimating unit 43 within a third designated period since the vehicle X has left the facility.

The number estimating unit 45 estimates the number of passengers of the vehicle X. The number of passengers may be estimated by detecting people from an image photographed by the imaging unit 191 (291) or may be detected with seating sensors (not illustrated) mounted on seats or an apparatus (not illustrated) which detects fastening of seat belts. In the case where it is estimated by the number estimating unit 45 that there is only one passenger on the vehicle X, the questioning unit 46 outputs a question to the passenger. In the case where it is determined by the visit determining unit 42 that the vehicle X has visited the facility and it is estimated by the number estimating unit 45 that there are a plurality of passengers on the vehicle X, the questioning unit 46 outputs a question to the passengers under the condition that a degree of certainty of estimation of the emotion of the passengers by the emotion estimating unit 43 does not become equal to or higher than a predetermined value within a designated period.

### (Operation of Facility Satisfaction Rate Calculating Apparatus)

Operation or functions of the facility satisfaction rate calculating apparatus 4 having the above-described configuration will be described.

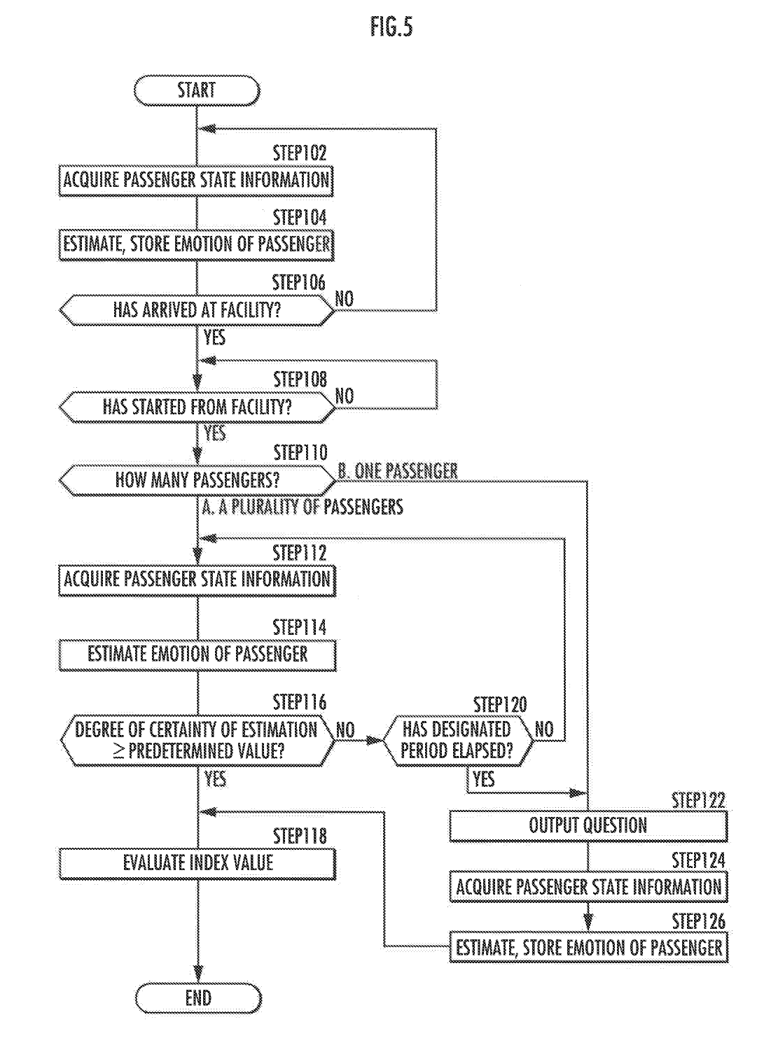

The information acquiring unit 41 acquires information indicating a state of a passenger of the vehicle X as the passenger state information (FIG. 5, STEP 102). For example, an image indicating expression of a passenger located in cabin space of the vehicle X or an aspect where a plurality of passengers have a conversation, imaged by the imaging unit 191 (291) may be acquired as the passenger state. Content of utterance of the passenger detected by the sound input unit 192 (292) may be acquired as the passenger state information. The passenger state information is stored and held in the storage unit 13 (23) in Chronological order with time measured by the clock 402.

The emotion estimating unit 43 estimates emotion of one or more passengers of the vehicle X based on the passenger state information acquired by the information acquiring unit 41 (FIG. 5, STEP 104). Specifically, the emotion of the passenger is estimated using the passenger state information as input and using a filter created through machine learning such as deep learning and support vector machine. For example, in the case where a moving image or sound information indicating an aspect where a plurality of passengers enjoying conversation is included in the passenger state information, the emotion of the plurality of passengers is estimated as positive emotion such as “like” and “fun”. The emotion estimation result is stored and held in the storage unit 13 (23) in chronological order with time measured by the clock 402.

The visit determining unit 42 determines whether or not the vehicle X has arrived at the facility (FIG. 5, STEP 106). For example, in the case where a predetermined period has elapsed since the IGN switch has switched from ON to OFF according to the vehicle information unit 12 and a current position of the vehicle X or the facility satisfaction rate calculating apparatus 4 measured by the GPS sensor 111 (211) is included in a region in the vicinity of the facility in a map held by the navigation unit 18, it is determined that the vehicle X has arrived at the facility. It is also possible to determine arrival by further setting conditions that the facility is set as a destination point at the navigation unit 18.

In the case where it is determined that the vehicle X has not arrived at the facility (FIG. 5, STEP 106 . . . NO), processing after acquisition of the passenger state information is repeated (see FIG. 5, STEP 102→STEP 104→STEP 106).

In the case where it is determined that the vehicle X has arrived at the facility (FIG. STEP 106 . . . YES), the visit determining unit 42 determines whether or not the vehicle X has started from the facility (FIG. 5, STEP 108 (see FIG. 5, STEP 108 . . . NO→STEP 108)). For example, in the case where a predetermined period has elapsed since the IGN switch has switched from OFF to ON according to the vehicle information unit 12 and a current position of the vehicle X or the facility satisfaction rate calculating apparatus 4 measured by the GPS sensor 111 (211) is deviated from the region in the vicinity of the facility, it is determined that the vehicle X has started from the facility.

In the case where it is determined that the vehicle X has started from the facility (FIG. 5, STEP 108 . . . YES), the number estimating unit 45 estimates the number of passengers of the vehicle X (FIG. 5, STEP 110). For example, the number of passengers in cabin space of the vehicle X is estimated by performing analysis processing on an image indicating an aspect of the cabin space of the vehicle X imaged by the imaging unit 191 (291).

In the case where it is estimated that there are a plurality of passengers (FIG. 5, STEP 110 . . . A), the information acquiring unit 41 acquires information indicating a state of the passengers of the vehicle X as the passenger state information (FIG. 5, STEP 112), The emotion estimating unit 43 then estimates emotion of the passengers based on the passenger state information within a designated period after the vehicle X has started from the facility, acquired by the information acquiring unit 41(FIG. 5, STEP 114).

The emotion estimating unit 43 determines whether or not a degree of certainty of estimation of the emotion of the passengers is equal to or higher than a predetermined value (FIG. 5, STEP 116).

In the case where it is determined that the degree of certainty of estimation of the emotion of the passengers is equal to or higher than the predetermined value (FIG. 5, STEP 116 . . . YES), the index value evaluating unit 44 evaluates an index value of a satisfaction rate of the passengers with respect to the facility based on the estimated emotion of the passengers within a predetermined period before the vehicle X has arrived at the facility in addition to the estimated emotion of the passengers within a designated period after the vehicle X has started from the facility, stored in the storage unit 13 (23) (FIG. 5, STEP 118). For example, as the estimated emotion of the passengers after the vehicle has started from the facility changes toward a positive side in a larger extent on the basis of the estimated emotion of the passengers before the vehicle X has arrived at the facility, there is tendency that the index value is evaluated as a larger value. On the other hand, as the estimated emotion of the passengers after the vehicle X has started from the facility changes toward a negative side in a larger extent, there is tendency that the index value is evaluated as a smaller value. A calculation result of the index value is stored in the storage unit 13 (23) in association with information relating to the facility and transmitted to the server 3 as appropriate.

The “designated period” and the “predetermined period” may he the same or different. The “designated period” may be adaptively set based on the estimated emotion of the passengers within the predetermined period before the vehicle has arrived at the facility.

In the case where it is determined that the degree of certainty of estimation of the emotion of the passengers is less than the predetermined value (FIG. 5, STEP 116 . . . NO), it is determined by the questioning unit 46 whether or not the designated period has elapsed since the vehicle X has left or started from the facility (FIG. 5, STEP 120). In the case where it is determined that the designated period has not elapsed (FIG. 5, STEP 120 . . . NO), processing after acquisition of the passenger state information is repeated (see FIG, 5, STEP 112→STEP 114 → . . . ).

In the case where it is determined that the designated period has elapsed, the questioning unit 46 outputs a question to the passengers (FIG. 5, STEP 122). By this means, speech of a question such as “how was ** (name of the facility)?” is output from the sound output unit 17(27), and alternatively or additionally, text indicating the question is displayed at the display unit 15 (25).

The information acquiring unit 41 acquires the passenger state information (FIG. 5, STEP 124). The passenger state information includes a moving image indicating action of the passenger such as nodding the head and shaking the head in addition to speech information such as “yes” and “no” of the passenger who has received the question. The emotion estimating unit 43 estimates emotion of the passenger based on the passenger state information acquired by the information acquiring unit 41 (FIG. 5, STEP 126). For example, in the case where positive utterance such as “yes”, “it was fun” and “I want to go again” of the passenger or a moving image indicating positive action or expression such as nodding the head and smiling is included in the passenger state information, the emotion of the passenger is highly likely to be estimated as positive emotion. On the other hand, in the case where negative utterance such as “no”, “not great” and “I will not go again” of the passenger or a moving image indicating negative action or expression such as shaking the head and frowning is included in the passenger state information, the emotion of the passenger is highly likely to be estimated as negative emotion.

The index value evaluating unit 44 then evaluates an index value of the satisfaction rate of the passenger with respect to the facility based on the estimated emotion of the passenger (FIG. 5, STEP 118).

In the case where it is estimated that there is one passenger (FIG. 5, STEP 110 . . . B), output of a question to the passenger by the questioning unit 46, acquisition of the passenger state information, estimation of emotion of the passenger and evaluation of the index value are executed (see FIG. 5, STEP 122→STEP 124→STEP 126→STEP 118). (Other embodiment 1 of the present invention)

While, in the above-described embodiment, the emotion of the passenger is estimated after it is distinguished whether or not to output a question according to the number estimation result (see FIG. 5, STEP 110→ . . . →STEP 118), as another embodiment, it is also possible to omit estimation of the number of passengers (see FIG. 5, STEP 110) and execute processing after acquisition of the passenger state information and estimation of the emotion of the passenger without outputting a question (see FIG. 5, STEP 112→STEP 114→ . . . →STEP 118), or execute processing after acquisition of the passenger state information and estimation of the emotion of the passenger while outputting a question (see FIG. 5, STEP 122→STEP 124→ . . . →STEP 118).

While, in the above-described embodiment, in the case where it is estimated by the number estimating unit 45 that there are a plurality of passengers on the vehicle X, a question is output to the passengers under the condition that a degree of certainty of estimation of the emotion of the passengers by the emotion estimating unit 43 does not become equal to or higher than the predetermined value within the designated period (see FIG. 5, STEP 110 . . . A→STEP 112→STEP 114→STEP 116 . . . NO→STEP 120 . . . YES→STEP 122), as another embodiment, in the case where it is estimated by the number estimating unit 45 that there are a plurality of passengers on the vehicle X, a question may be output to the passengers regardless of the degree of certainty of estimation of the emotion of the passengers. Further, the index value of the satisfaction rate of the passengers (with respect to the facility) may be evaluated regardless of the degree of certainty of estimation of the emotion of the passengers.

While, in the above-described embodiment, the index value of the satisfaction rate (degree) of the passenger with respect to the facility is evaluated based on the estimated emotion of the passenger within the predetermined period before the vehicle X has arrived at the facility in addition to the estimated emotion of the passenger within the designated period after the vehicle X has started from the facility, stored in the storage unit 13 (23) (see FIG. 5, STEP 118), as another embodiment, the index value of the satisfaction rate of the passenger with respect to the facility may be evaluated only based on the estimated emotion of the passenger within the designated period after the vehicle X has started from the facility. For example, in the case where the estimated emotion of the passenger after the vehicle X has started from the facility is positive and as a positive degree (emotion value) is larger, there is tendency that the index value is evaluated as a larger value. On the other hand, in the case where the estimated emotion of the passenger after the vehicle X has started from the facility is negative, and as a negative degree (emotion value) is larger, there is tendency that the index value is evaluated as a smaller value,

### (Other Embodiment 2 of the Present Invention)

Further, while a question is output in the case where there is one passenger (FIG. 5, STEP 122), as another embodiment of the present invention, the question is output both in the case where there is one passenger and in the case where there are a plurality of passengers. In this case, in the case where, for example, the obtained satisfaction rate with respect to the facility is deviated from a normal average value for the facility, reasons are collected by asking questions as to why the facility is good (satisfactory) or why the facility is bad (not satisfactory). The questions may relate to comparison with other facilities the passenger has visited in the past or suggestions for the future.

### (Other Embodiment 3 of the Present Invention)

Further, as another embodiment of the present invention, the collected index values of the satisfaction rate with respect to the facility are utilized. For example, it is possible to tally index values of the satisfaction rate with respect to the facility at the server 3 a plurality of times, create an analysis report as user evaluation with respect to the facility and further, matters to be improved, and sell the analysis report to the facility. The revenues obtained as a result of sale may be returned to the passengers who cooperate with provision of the index values of the satisfaction rate with respect to the facility by cash or also can be reduced by providing a wireless communication usage amount, content such as music and video, and further, information which is originally paid information, such as more detailed facility information, without charge or at a low price.

### (Other Embodiment 4 of the Present Invention)

Further, as another embodiment of the present invention, the collected index values of the satisfaction rate with respect to the facility are utilized in a different manner. For example, the index values of the satisfaction rate with respect to the facility are tallied at the server 3 a plurality of times, and the navigation unit 18 preferentially sets a facility for which the index values are evaluated as high values as a destination when the navigation unit 18 selects a route. By performing setting in this manner, it is possible to easily set a so-called “good facility” which is highly evaluated by a plurality of people as the destination.

### (Effect)

According to the facility satisfaction rate calculating apparatus of the present invention, it is possible to realize improvement of estimation accuracy of a satisfaction rate of a passenger of a vehicle X with respect to a facility.
1. agent apparatus
2 mobile terminal apparatus
3 server
4 facility satisfaction rate calculating apparatus
11 sensor unit
111 UPS sensor
112 vehicle speed sensor
113 gyro sensor
12 vehicle information unit
13 storage unit
14 radio unit
141 near field wireless communication unit
142 wireless communication network communication unit
15 display unit
16 operation input unit
17 audio unit
18 navigation unit
191 imaging unit (in-vehicle camera)
192 sound input unit (microphone)
21 sensor unit
211 GPS sensor
213 gyro sensor
23 storage unit
231 data storage unit
232 application storage unit
24 radio unit
241 near field wireless communication unit
242 wireless communication network communication unit
25 display unit
26 operation input unit
27 sound output unit
291 imaging unit (camera)
292 sound input unit (microphone)
41 information acquiring unit
42 visit determining unit
43 emotion estimating unit
44 index value evaluating unit
45 number estimating unit
46 questioning unit
X vehicle (mobile object)

What is claimed is:

1. A facility satisfaction rate calculating apparatus comprising:
a visit determining unit configured to determine whether or not a vehicle as visited a facility;
an emotion estimating unit configured to estimate emotion of one or more passengers of the vehicle based on information relating to a state of the one or more passengers;
an index value evaluating unit configured to, in a case where it is determined by the visit determining unit that the vehicle has visited the facility, evaluate an index value of a satisfaction rate of the one or more passengers with respect to the facility based on the emotion of the one or more passengers estimated by the emotion estimating unit within a designated period since the vehicle has left the facility;
a number estimating unit configured to estimate a number of passengers of the vehicle; and
a questioning unit configured to, in a case where it is estimated by the number estimating unit that there is only one passenger on the vehicle, output a question to the passenger.

2. The facility satisfaction rate calculating apparatus according to claim 1,
wherein, in a case where it is determined by the visit determining unit that the vehicle has visited the facility and it is estimated by the number estimating unit that there are a plurality of passengers on the vehicle, the questioning unit outputs a question to the passengers under a condition that a degree of certainty of estimation of emotion of the passengers by the emotion estimating unit does not become equal to or higher than a predetermined value within the designated period.

3. The facility satisfaction rate calculating apparatus according to claim 1, wherein the index value evaluating unit evaluates an index value of a satisfaction rate of the one or more passengers with respect to the facility based on emotion of the one or more passengers estimated by the emotion estimating unit within a predetermined period before the vehicle has arrived at the facility in addition to emotion of the one or more passengers estimated by the emotion estimating unit within the designated period since the vehicle has left the facility,

4. The facility satisfaction rate calculating apparatus according to claim 1,
wherein information relating to a state of the one or more passengers of the vehicle is at least one of expression and action of the one or more passengers photographed by a camera and speech of the one or more passengers collected with a microphone.

5. A mobile object comprising the facility satisfaction rate calculating apparatus according to claim 1.
